(19) United States
(12) Patent Application Publication
(10) Pub. No.: US 2016/0001899 A1
(43) Pub. Date: Jan. 7, 2016

(54) Gas Envelope Propulsion System and Related Methods

(71) Applicant: Daniel J. Adcock, Edwardsville, IL (US)

(72) Inventor: Daniel J. Adcock, Edwardsville, IL (US)

(21) Appl. No.: 14/733,096

(22) Filed: Jun. 8, 2015

Related U.S. Application Data
(60) Provisional application No. 62/021,647, filed on Jul. 7, 2014.

(51) Int. Cl. B64G 1/40

(52) U.S. Cl. CPC B64G 1/406

(57) ABSTRACT

Disclosed are exemplary embodiments of systems and methods for gas envelope propulsion. In an exemplary embodiment, a propulsion system generally includes a power plant, and an inelastic gas envelope configured to receive a gas independently of the power plant. The power plant is configured to provide thrust for moving the gas envelope skyward, and the gas envelope is further configured to expel at least some of the gas to provide additional thrust.

### CROSS-REFERENCE TO RELATED APPLICATION

This application claims the benefit of U.S. Provisional Application No. 62/021,647, filed on Jul. 7, 2014. The entire disclosure of the above application is incorporated herein by reference.

### FIELD

The present disclosure relates to a gas envelope propulsion system and related methods.

### BACKGROUND

This section provides background information related to the present disclosure which is not necessarily prior art.

The spaceflight industry is currently growing along with commercial development of space vehicles for carrying humans and/or cargo. Space vehicle developers aim to provide safe, efficient and low-cost vehicles. Propulsion systems for sending vehicles into space typically utilize solid rocket fuel, liquid rocket fuel, or combinations of solid and liquid fuels. Hybrid rocket motors that use gas oxidizers mixing with solid fuel also have been used.

### SUMMARY

This section provides a general summary of the disclosure, and is not a comprehensive disclosure of its full scope or all of its features.

According to various aspects, exemplary embodiments are disclosed of systems and methods for gas envelope propulsion. In an exemplary embodiment, a propulsion system generally includes a power plant, and an inelastic gas envelope configured to receive a gas independently of the power plant. The power plant is configured to provide thrust for moving the gas envelope skyward, and the gas envelope is further configured to expel at least some of the gas to provide additional thrust.

In another example embodiment, a propulsion system generally includes an inelastic gas envelope for receiving a gas, and a power plant for providing thrust to move the envelope upward. The envelope is configured to expel, when thrust upward by the power plant, at least some of the gas to reduce the pressure of the gas in the envelope at a rate slower than a rate of an increase in pressure induced in the envelope by decreasing ambient pressure.

Also disclosed is an example method that generally includes moving an inelastic envelope of gas upward into decreasing ambient pressure. The moving is performed using a thrust producing power plant. As the envelope is moved into the decreasing ambient pressure, at least some of the gas from the envelope to is released to provide additional thrust for upward movement.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a vertical sectional view of an example propulsion system in accordance with one embodiment of the disclosure; and

FIG. 2 is a vertical sectional view of the aft end of an example solid rocket motor casing in accordance with one embodiment of the disclosure.

Corresponding reference numerals indicate corresponding parts throughout the several views of the drawings.

### DETAILED DESCRIPTION

Example embodiments will now be described more fully with reference to the accompanying drawings.

The inventor hereof has recognized that success in lifting large vehicles into space has been limited by the expense and performance limitations of the various devices used to perform the lifting. The inventor also has recognized that new methods could be used to expand the utility, lower the cost, and improve the safety of moving persons and cargo to outer space. Accordingly, the inventor has developed and discloses herein exemplary embodiments of a gas envelope propulsion system and related methods. In one example embodiment, a gas envelope propulsion system includes an inelastic gas envelope having an aft end connected with a nozzle. A thrust producing power plant is attached to the gas envelope as a means of propelling the entire system skyward. The gas envelope is moved upward into decreasing ambient pressure by the power plant. As the envelope is moved into decreasing ambient pressure, at least some of the gas from the envelope to is released to provide additional thrust for upward movement.

Although various embodiments are discussed herein with reference to a propulsion system having a small gas envelope (e.g., an envelope about 22 feet long) and a power plant that includes a plurality of solid rocket motors, the disclosure is not so limited. It should be noted generally that gas envelope embodiments could be provided in a wide range of sizes, shapes, proportions, materials, configurations, etc. Additionally or alternatively, various embodiments of power plants could be provided in a wide range of sizes, shapes, proportions, materials, configurations, etc. and could be powered by various types of fuels to provide thrust for various gas envelope embodiments. Propulsion system embodiments in accordance with the disclosure may have various configurations depending on what performance characteristics are desired. In some embodiments, a gas envelope could be configured for transporting a payload of cargo and/or passengers into space, and a power plant could be configured to provide thrust sufficient to transport the gas envelope and the payload.

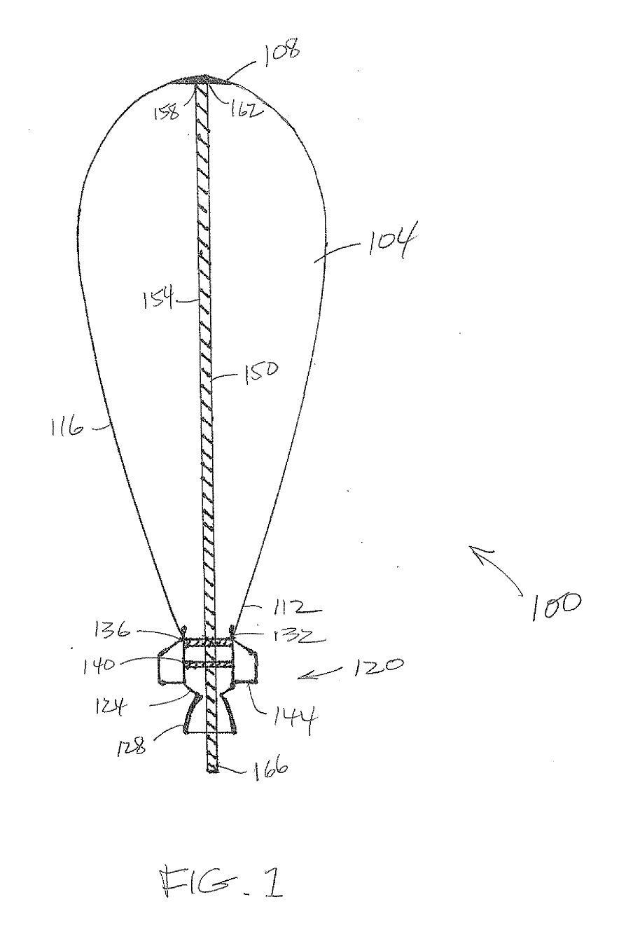

With reference now to the figures, FIG. 1 illustrates an exemplary embodiment of a gas envelope propulsion system embodying one or more aspects of the present disclosure. As shown in FIG. 1, an example propulsion system 100 includes an inelastic gas-impermeable envelope 104 having an aerodynamic shape, e.g., in which a forward end 108 of the envelope 104 is larger than an aft end 112. An outer surface 116 of the envelope 104 may be ridged, semi-ridged, smooth, etc. and/or may have various combinations of textures configured to provide one or more desired aerodynamic characteristics. The aft end 112 of the envelope 104 is attached to a nozzle 120 having a convergent section 124 and a divergent section 128. The envelope 104 is attached at an attachment point 132 on or near a centering ring 136 of the convergent section 124. Another centering ring 140 of the convergent section 124 provides an attachment point for stabilizing fins 144. The nozzle 120 is an example only. Various nozzle configurations are possible, dependent, e.g., on fuel properties, anticipated pressures and temperatures, etc.

The envelope 104 is capable of receiving, e.g., being filled with, a gas and/or a mixture of gases, e.g., through the nozzle 120. The gas(es) may include helium, although in various envelope embodiments air and/or other gas(es) could be used. Unless otherwise indicated, the term “gas” will be used herein to refer to a pure gas and/or to a combination of various gases. In various propulsion system embodiments, a gas envelope may be sealed shut at a nozzle, e.g., when it has been filled with gas to a desired pressure. Additionally or alternatively, in various embodiments a gas envelope may be disconnected from a nozzle, e.g., when the envelope has been transported to its destination and/or is to be put to a subsequent use in space.

Referring again to FIG. 1, the example envelope 104 is about 22 feet long and has a maximum width of about 8 feet. The envelope 104 has a volume of about 750 cubic feet. The envelope 104 is made, e.g., of 3.5-ounce urethane coated rip-stop nylon material. Other or additional materials could be used to construct an envelope, including (without limitation) other or additional flexible materials such as Mylar® or other plastic sheet, Kevlar®, aluminum, various rigid materials, etc. The particular envelope material(s) used would depend on various factors, including but not limited to gas envelope propulsion system size, material strength, cost, etc. In various embodiments, other or additional openings may be provided in a gas envelope through which to fill the envelope with gas and that may be sealed shut, e.g., after the envelope has been filled with gas to a desired pressure level. In various embodiments, the size of an opening at the aft end of a gas envelope may be controllable, e.g., to control gas pressure and/or temperature, amount of gas exiting the envelope, and/or other conditions relating to gas within the envelope before, during and/or after flight.

The propulsion system 100 includes a power plant 150 attached to the envelope 104 and configured to provide thrust for transporting the envelope 104 as further described below. In various embodiments, all or part of a power plant may be reversibly attached to a gas envelope, e.g., thereby allowing all or part of the power plant to be jettisoned, e.g., after the power plant no longer provides thrust to the attached envelope. In the present example embodiment, the power plant 150 includes a solid rocket motor casing 154 the greater part of which is positioned inside the envelope 104. A forward end 158 of the motor casing 154 is attached to the forward end 108 of the envelope 104 at an attachment point 162 inside the envelope 104. An aft end 166 of the motor casing 154 is open to ambient pressure and extends outside the nozzle 120. The casing 154 is made, e.g., of 1⅜-inch-diameter chromoly tubing.

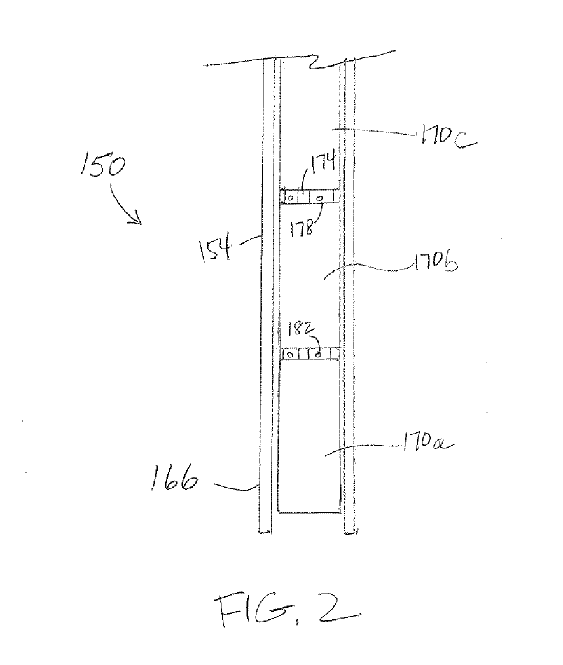

The aft end 166 of the motor casing 154 is shown in FIG. 2. The casing 154 holds a plurality of solid rocket motors, referred to collectively by reference number 170, three of which are shown in FIG. 2. The motors 170 are positioned sequentially in the casing 154. Juxtaposed motors 170 are separated from each other, e.g., by a distance of ⅛ inch, by spacers 174. The motors 170 are stacked against, and may be affixed to, a plug or other barrier (not shown) in the forward end 158 of the casing 154. In the present example embodiment, juxtaposed motors 170 are held together, e.g., by packing tape 178 (e.g., Scotch® tape) or other medium having sufficient tensile strength to hold the motors 170 together and also having desired thermal disintegration properties so as to allow a spent motor 170 to become disengaged from the casing 154 as described below. Venting holes 182 are provided in the tape 178 between the motors 170. In the example propulsion system 100, about sixty-four (64) motors 170 are provided. The motors 170 are, e.g., Estes® F15-8 solid rocket motors that together provide about 10 pounds of black powder fuel.

At lift-off of a given propulsion system embodiment, a continuous process would begin whereby the propulsion system is propelled toward the sky, into decreasing ambient pressure. Potential energy may be converted into kinetic energy in several ways that can reinforce one another as skyward flight progresses. In various embodiments, a gas envelope propulsion system may be propelled past earth atmosphere into space.

With reference to the propulsion system 100, the inventor has observed that lift-off and flight can occur substantially as follows. Before the gas envelope 104 and power plant 150 are launched, the envelope 104 is filled, e.g., with 750 cubic feet of helium gas. The helium gas provides lift to the tethered envelope 104, the forward end 108 of which is directed upward. The aft end 112 of the envelope 104 is directed toward the ground and, in present example embodiment, is left open to ambient pressure.

To launch the propulsion system 100, an igniter may be used to ignite the aft-most rocket motor 170a. Hot gases then exit the aft-most motor 170a, e.g., at supersonic speed to produce, e.g., about 3.4 pounds of thrust. Additionally, the helium gas inside the envelope 104 provides, e.g., about 10 pounds of lift off the launch location. The thrust and lift cause the propulsion system 100 to begin ascending into the sky. When the aft-most rocket motor 170a has produced average thrust of about 3.4 pounds for about 3.6 seconds, an eight-second delay is followed by ignition of an ejection charge in the motor 170a. The ejection charge pushes cold gases between the motor stages out through the vent holes 182 in the tape 178. Hot gas produced by the ejection charge slices through the tape 178 holding the aft-most motor 170a together with the juxtaposed motor 170b, and substantially at the same time ignites the motor 170b. The aft-most motor 170a is ejected out through the aft end 166 of the motor casing 154. The foregoing process is repeated for each of the motors 170 in sequence, producing thrust over a time period of about 12 minutes and 20 seconds. As spent solid rocket motors 170 and spent fuel are ejected out of the motor casing 154, overall weight of the propulsion system 100 is decreased by the weight of the ejected components.

As the propulsion system 100 begins to move upward, pressure of the helium gas inside the inelastic envelope 104 begins to increase relative to ambient pressure as ambient pressure decreases. At least some of the pressurized helium in the envelope 104 is expelled through the nozzle 120, thereby contributing to the thrust from the motors 170. Additionally, in the present example embodiment, as the rocket motors 170 are ignited in sequence, heat from the motors 170 is transferred through the motor casing 154 into the gas envelope 104. Motors 170 that are provided at or near the forward end 158 of the motor casing 154 can tend to lose some of their thrust, e.g., due to exhaust gas friction against the motor casing 154. Heat from such friction may migrate through the motor casing 154 and into the helium gas in the envelope 104. The heat further increases the pressure of the gas inside the envelope 104. At least some of the heat-pressurized gas may be expelled from the envelope 104 through the nozzle 120, thereby adding to the overall thrust of the propulsion system 100. Such heat can be particularly useful if produced when a propulsion system is traveling in the stratosphere, where ambient temperatures can reach −100 degrees Fahrenheit.

In various embodiments, where a gas envelope propulsion system is moved sufficiently fast from launch into decreasing ambient pressure, gas pressure in a gas envelope reaches a level at which the gradient of decreasing ambient pressure from ground level to outer space can be used to support an altitude/thrust feedback loop. For example, referring to the example propulsion system 100, thrust created by gas expelled through the nozzle 120 moves the propulsion system 100 further into decreasing ambient pressure, which increases the relative pressure of the gas in the envelope, which (when some of the gas is expelled) contributes to the thrust, and so on. When the rates of gas pressure buildup in the envelope 104, venting of gas through the nozzle 120, and speed of travel through decreasing ambient pressure are at appropriate levels, the propulsion system 100 continues to produce useful thrust.

In various embodiments, a propulsion system gas envelope moving into decreasing ambient pressure can continue to produce useful thrust as long as pressure in the envelope is increased faster than pressure in the envelope is decreased by gas exiting the envelope. Various factors, including but not necessarily limited to mass of propulsion system components, envelope volume, speed of travel by the envelope into decreasing ambient pressure, and nozzle opening size can affect whether and/or how fast such a pressure differential may be reached. Such a process may continue, e.g., until rocket motors are spent and pressures inside and outside the gas envelope are at equilibrium. For various propulsion system embodiments configured to travel to space, equilibrium would occur, e.g., when all of the gas has exited the envelope and the propulsion system has reached the vacuum of space.

Referring again to the example propulsion system 100, after launch the system may be provided with about 10 pounds of lift from helium gas and about 3 pounds of thrust from the motors 170. The system 100 may face an aerodynamic frontal area of about 8 feet in diameter. At low altitudes, the system 100 does not move very fast. For example, the system 100 may take more than 2 minutes, at an average speed of about 30 miles per hour, to reach an altitude of one mile. As the air gets thinner and relative pressure increases inside the gas envelope 104, speed of the envelope 104 may steadily increase. When the envelope 104 has gone beyond maximum aerodynamic resistance, e.g., at an altitude of about 40,000 to 45,000 feet, 80 percent of air molecules would be below the envelope 104, which would be at about maximum pressure. At such time the curve of acceleration of the envelope 104 may become very steep, and the envelope 104 may move very rapidly toward equilibrium.

In various embodiments, other or additional devices for controlling parameters including (without limitation) thrust, lift, pressure, temperature, heat transfer, weight, envelope and/or gas volume, envelope orifice size(s), etc. may be provided for use in launching and/or flying a gas envelope propulsion system to a desired atmospheric and/or space destination. Where a given propulsion system embodiment is large, e.g., where its gas envelope has a size comparable to that of a cruise ship, at least part of the propulsion system power plant, e.g., one or more solid rocket motors, could be removed, jettisoned and/or returned to earth. The gas envelope, e.g., could be capped off and filled with air to provide a space station or other facility.

In other embodiments, a power plant may be configured for attachment at least partly to the exterior of a gas envelope. For example, in some embodiments a gas envelope could be flanked by two or more power plants configured to provide thrust and/or heat for the envelope. Power plant embodiments could include (without limitation) solid rocket motors, liquid rocket motors, chemical rocket motors, thermal rocket motors, hybrid rocket motors, rotor craft such as quadcopters, a single power plant stage, multiple stages, combinations of the foregoing, etc.

Embodiments of the foregoing systems and methods can be used to move people and cargo into outer space safely, efficiently, and at low cost. Because the use of conventional rocket fuel can be reduced in various gas envelope propulsion system embodiments, fuel costs and fuel-associated pollution can be reduced. Various gas envelope propulsion system embodiments, or components thereof, can be configured for reusability. The relatively slow take-off speed of a gas envelope propulsion system reduces G forces on experimental and other equipment. In contrast, many if not most experimental equipment failures occur on liftoff, when conventional rockets are used. Gas envelope propulsion system embodiments are particularly suited for putting ultra-large habitats into space.

Gas envelope propulsion system embodiments can be used as technology multipliers when used with existing rocket systems. For example, mid-sized rockets are currently in use for carrying satellites and spacecraft into and beyond earth orbit. The inventor has observed that such rockets typically use up most of their rocket fuel in carrying small metal spacecraft to altitudes of about 100 km. A rocket of the same or similar size and capacity could be used in an envelope propulsion system, to propel into space a very large gas envelope, e.g., an envelope over 1600 feet long and 300 feet wide. Such an envelope could be preconfigured to provide a habitat that, once in space, could be capped off and filled with air, thus making it possible for large numbers of people to be transported into space for extended stays. In various embodiments, such a rocket may still have a large amount of rocket fuel available after having propelled a large gas envelope into space. It is contemplated that an embodiment of a gas envelope propulsion system could be used to transport a large habitat to the moon or other destination in space.

The inventor also has observed that liquid fuel rockets are currently used in sub-orbital flights of reusable launch vehicles that travel up and down in one continuous movement. Such a rocket could be configured in a gas envelope propulsion system embodiment, e.g., to reach space. Upon reaching space, the rocket would still have most of its liquid fuel, which could be used to maintain station at a predetermined altitude above ground level. Thus the vehicle would be capable of staying up longer, e.g., to conduct a scientific experiment and to collect more data than would be possible during a typical up-and-down flight.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or, for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A propulsion system comprising:
a power plant; and
an inelastic gas envelope configured to receive a gas independently of the power plant;
wherein the power plant is configured to provide thrust for moving the gas envelope skyward, and the gas envelope is further configured to expel at least some of the gas to provide additional thrust.

2. The system of claim 1, wherein the power plant is thermally connected with the gas envelope to provide heat to the gas.

3. The system of claim 2, wherein the power plant is at least partly surrounded by the gas envelope.

4. The system of claim 1, further comprising a nozzle through which the envelope is configured to expel the at least some of the gas.

5. The system of claim 1, wherein the gas includes helium.

6. The system of claim 1, wherein the gas in the envelope increases in pressure relative to decreasing ambient pressure, and the envelope is configured to expel the at least some of the gas to reduce the pressure of the gas in the envelope at a rate slower than a rate of the increase in pressure.

7. The system of claim 1, wherein the power plant comprises one or more rocket motors.

8. A propulsion system comprising:
an inelastic gas envelope for receiving a gas; and
a power plant for providing thrust to move the envelope upward;
wherein the envelope is configured to expel, when thrust upward by the power plant, at least some of the gas to reduce the pressure of the gas in the envelope at a rate slower than a rate of an increase in pressure induced in the envelope by decreasing ambient pressure.

9. The system of claim 8, wherein the power plant is further configured to release heat into the gas.

10. The system of claim 8, wherein the gas envelope is configured to surround at least part of the power plant.

11. The system of claim 8, wherein the gas envelope comprises a nozzle through which the at least some of the gas is expelled.

12. The system of claim 8, wherein the gas provides lift to the envelope.

13. The system of claim 8, wherein the power plant comprises one or more rocket motors.

14. A method comprising:
moving an inelastic envelope of gas upward into decreasing ambient pressure, the moving performed using a thrust producing power plant;
as the envelope is moved into the decreasing ambient pressure, releasing at least some of the gas from the envelope to provide additional thrust for upward movement.

15. The method of claim 14, further comprising transferring heat from the power plant to the gas to increase the additional thrust.

16. The method of claim 14, performed to move the envelope past earth atmosphere.

17. The method of claim 14, wherein the envelope is at least partially filled with the gas before the moving is performed, the method further comprising providing lift to the envelope using the gas.

18. The method of claim 14, wherein using the thrust producing power plant comprises using one or more rocket motors.

19. The method of claim 14, wherein the releasing is performed at a rate slower than a rate of an increase in pressure induced in the envelope by decreasing ambient pressure.

20. The method of claim 14, wherein the releasing is performed using a nozzle of the envelope.
